(19) United States
(12) Patent Application Publication
(10) Pub. No.: US 2018/0255542 A1
(43) Pub. Date: Sep. 6, 2018

(54) METHOD AND APPARATUS FOR TRANSMITTING AND RECEIVING UPLINK IN WIRELESS COMMUNICATION SYSTEM

(71) Applicant: LG ELECTRONICS INC., Seoul (KR)

(72) Inventors: Hanbyul SEO, Seoul (KR); Suckchel YANG, Seoul (KR); Yunjung YI, Seoul (KR)

(21) Appl. No.: 15/573,378

(22) PCT Filed: May 13, 2016
(86) PCT No.: PCT/KR2016/005105

§ 371 Date: Apr. 9, 2018

Related U.S. Application Data
(60) Provisional application No. 62/161,238, filed on May 13, 2015.
(60) Provisional application No. 62/161,899, filed on May 15, 2015.

(51) Int. Cl. H04W 72/04; H04L 1/18; H04L 1/16

(52) U.S. Cl. CPC H04W 72/0413; H04W 4/70; H04L 1/1657; H04L 1/1812

(57) ABSTRACT

An embodiment of the present invention relates to a method for a machine type communication (MTC) user equipment (UE) to send uplink control information in a wireless communication system that supports a MTC. Specially, the method is configured to comprise: a step in which the MTC UE receives an MTC physical downlink control channel (MPDCCH) in a first sub-band from a base station; a step of receiving a physical downlink shared channel (PDSCH) on the basis of the MPDCCH; a step of determining a physical uplink control channel (PUCCH) resource for the PDSCH using a HARQ-ACK resource offset (ARO) indicated by the MPDCCH; and a step of sending the uplink control information via the PUCCH resource.

### TECHNICAL FIELD

Following description relates to a wireless communication system, and more particularly, to a method of transmitting HARQ (hybrid automatic repeat request)-ACK in an MTC (machine type communication) system and an apparatus therefor.

### BACKGROUND ART

Wireless communication systems have been widely deployed to provide various types of communication services such as voice or data. In general, a wireless communication system is a multiple access system that supports communication between multiple users by sharing available system resources (e.g., bandwidth, transmission power and the like). For example, multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi-Carrier Frequency Division Multiple Access (MC-FDMA) system.

### DISCLOSURE OF THE INVENTION

### Technical Tasks

A technical task of the present invention is to provide a method of transmitting and receiving HARQ-ACK in a wireless communication system supporting MTC.

Another technical task of the present invention is to provide an apparatus for transmitting and receiving HARQ-ACK in a wireless communication system supporting MTC.

Technical tasks obtainable from the present invention are non-limited the above mentioned technical tasks. And, other unmentioned technical tasks can be clearly understood from the following description by those having ordinary skill in the technical field to which the present invention pertains.

### Technical Solution

A method of transmitting uplink control information, which is transmitted by an MTC (machine type communication) UE in a wireless communication supporting MTC, the method comprising: receiving, by the MTC UE, an MPDCCH (MTC physical downlink control channel) in a first subband from a base station; receiving a PDSCH (physical downlink shared channel) based on the MPDCCH; determining a PUCCH (physical uplink control channel) resource for the PDSCH using an ARO (HARQ-ACK resource offset) indicated by the MPDCCH; and transmitting the uplink control information via the PUCCH resource, wherein the ARO is defined to move the PUCCH resource to a PUCCH resource corresponding to a second subband of an index lower than an index of the first subband. Another technical task of the present invention is to provide an apparatus for transmitting and receiving HARQ-ACK in a wireless communication system supporting MTC.

Additionally or alternatively, an amount of movement of the PUCCH resource moved by the ARO is determined based on the index of the first subband.

Additionally or alternatively, the ARO corresponds to,

$$- {\sum }_{i = Y}^{m - 1} {N}_{ECCE , i} + a ,$$

wherein the m corresponds to the index of the first subband, wherein the i corresponds to an index of a subband on which a specific MPDCCH is transmitted, wherein the NECCE,I corresponds to the number of resource units existing in the subband index i, and wherein the a corresponds to an offset value.

Additionally or alternatively, the Y corresponds to 0.

Additionally or alternatively, the Y is determined according to the index of the first subband.

Additionally or alternatively, the ARO is calculated under the assumption that the number of MPDCCH resource units is consistent in the subband.

A method of receiving uplink control information, which is received by a base station in a wireless communication supporting MTC (machine type communication), the method comprising: transmitting, by the base station, an MPDCCH (MTC physical downlink control channel) to an MTC UE in a first subband; transmitting a PDSCH (physical downlink shared channel) based on the MPDCCH; and receiving the uplink control information on the PDSCH from the MTC UE via a PUCCH (physical uplink control channel) resource, wherein the PUCCH resource is determined using an ARO (HARQ-ACK resource offset) and wherein the ARO is defined to move the PUCCH resource to a PUCCH resource corresponding to a second subband of an index lower than an index of the first subband.

Additionally or alternatively, an amount of movement of the PUCCH resource moved by the ARO is determined based on the index of the first subband.

Additionally or alternatively, the ARO corresponds to

$$- {\sum }_{i = Y}^{m - 1} {N}_{ECCE , i} + a ,$$

wherein the m corresponds to the index of the first subband, wherein the i corresponds to an index of a subband on which a specific MPDCCH is transmitted, wherein the N_{ECCE,I} corresponds to the number of resource units existing in the subband index i, and wherein the a corresponds to an offset value.

Additionally or alternatively, the Y corresponds to 0.

Additionally or alternatively, the Y is determined according to the index of the first subband.

Additionally or alternatively, the ARO is calculated under the assumption that the number of MPDCCH resource units is consistent in the subband. An MTC (machine type communication) UE transmitting uplink control information in a wireless communication supporting MTC, the MTC UE comprising: a transceiver configured to transceive a signal with a base station; and a processor wherein the processor is configured to: control the transceiver, the processor configured to receive an MPDCCH (MTC physical downlink control channel) in a first subband from a base station, control the transceiver to receive a PDSCH (physical downlink shared channel) based on the MPDCCH, determine a PUCCH (physical uplink control channel) resource for the PDSCH using an ARO (HARQ-ACK resource offset) indicated by the MPDCCH, and control the transceiver to transmit the uplink control information via the PUCCH resource, wherein the ARO is defined to move the PUCCH resource to a PUCCH resource corresponding

### Advantageous Effects

According to the present invention, it is able to reduce a collision of a PUCCH resource and efficiently receive a reception confirmation response in an MTC system.

Effects obtainable from the present invention may be non-limited by the above mentioned effect. And, other unmentioned effects can be clearly derived and understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram illustrating a structure of a radio frame.

FIG. 2 is a diagram illustrating a resource grid for a downlink slot.

FIG. 3 is a diagram illustrating a structure of a downlink subframe.

FIG. 4 is a diagram illustrating a structure of an uplink subframe.

FIG. 5 is a diagram of a form that PUCCH formats map to PUCCH regions in an uplink physical resource block;

FIG. 6 is a diagram illustrating an example of determining a PUCCH resource for ACK/NACK;

FIG. 7 is a diagram illustrating a structure of an ACK/NACK channel in case of a normal CP;

FIG. 8 is a diagram illustrating a structure of a CQI channel in case of a normal CP;

FIG. 9 is a diagram illustrating a PUCCH channel structure using block spreading;

FIG. 10 is a diagram for explaining a scheme of transmitting uplink control information via PUSCH;

FIG. 11 is a diagram for explaining a reception confirmation response in TDD;

FIG. 12 is a flowchart for a method of determining a PUCCH resource according to one embodiment of the present invention;

FIG. 13 is a diagram for explaining a method of determining a HARQ-ACK resource according to an ARO value in accordance with one embodiment of the present invention;

FIG. 14 illustrates a base station and a user equipment applicable to embodiments of the present invention.

### BEST MODE

### Mode for Invention

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions or features of any one embodiment may be included in another embodiment and may be replaced with corresponding constructions or features of another embodiment.

In the embodiments of the present invention, a description is made, centering on a data transmission and reception relationship between a Base Station (BS) and a User Equipment (UE). The BS is a terminal node of a network, which communicates directly with a UE. In some cases, a specific operation described as performed by the BS may be performed by an upper node of the BS.

Namely, it is apparent that, in a network comprised of a plurality of network nodes including a BS, various operations performed for communication with a UE may be performed by the BS or network nodes other than the BS. The term ‘BS’ may be replaced with the term ‘fixed station’, ‘Node B’, ‘evolved Node B (eNode B or eNB)’, ‘Access Point (AP)’, etc. The term ‘relay’ may be replaced with the term ‘Relay Node (RN)’ or ‘Relay Station (RS)’. The term ‘terminal’ may be replaced with the term ‘UE’, ‘Mobile Station (MS)’, ‘Mobile Subscriber Station (MSS)’, ‘Subscriber Station (SS)’, etc.

Specific terms used for the embodiments of the present invention are provided to help the understanding of the present invention. These specific terms may be replaced with other terms within the scope and spirit of the present invention.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

The embodiments of the present invention can be supported by standard documents disclosed for at least one of wireless access systems, Institute of Electrical and Electronics Engineers (IEEE) 802, 3rd Generation Partnership Project (3GPP), 3GPP Long Term Evolution (3GPP LTE), LTE-Advanced (LTE-A), and 3GPP2. Steps or parts that are not described to clarify the technical features of the present invention can be supported by those documents. Further, all terms as set forth herein can be explained by the standard documents.

Techniques described herein can be used in various wireless access systems such as Code Division Multiple Access (CDMA), Frequency Division Multiple Access (FDMA), Time Division Multiple Access (TDMA), Orthogonal Frequency Division Multiple Access (OFDMA), Single Carrier-Frequency Division Multiple Access (SC-FDMA), etc. CDMA may be implemented as a radio technology such as Universal Terrestrial Radio Access (UTRA) or CDMA2000. TDMA may be implemented as a radio technology such as Global System for Mobile communications (GSM)/General Packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved-UTRA (E-UTRA) etc. UTRA is a part of Universal Mobile Telecommunications System (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. WiMAX can be described by the IEEE 802.16e standard (Wireless Metropolitan Area Network (WirelessMAN)-OFDMA Reference System) and the IEEE 802.16m standard (WirelessMAN-OFDMA Advanced System). For clarity, this application focuses on the 3GPP LTE and LTE-A systems. However, the technical features of the present invention are not limited thereto.

LTE/LTE-A Resource Structure/Channel

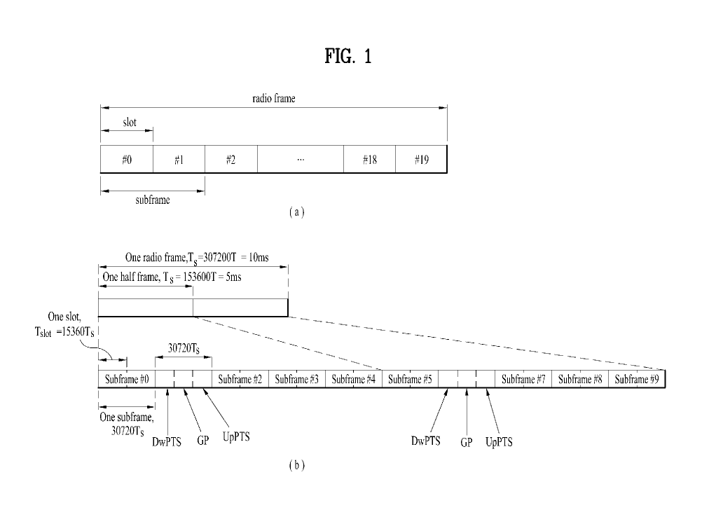

With reference to FIG. 1, the structure of a radio frame will be described below.

In a cellular Orthogonal Frequency Division Multiplexing (OFDM) wireless packet communication system, uplink and/or downlink data packets are transmitted in subframes. One subframe is defined as a predetermined time period including a plurality of OFDM symbols. The 3GPP LTE standard supports a type-1 radio frame structure applicable to Frequency Division Duplex (FDD) and a type-2 radio frame structure applicable to Time Division Duplex (TDD).

FIG. 1(a) illustrates the type-1 radio frame structure. A downlink radio frame is divided into 10 subframes. Each subframe is further divided into two slots in the time domain. A unit time during which one subframe is transmitted is defined as a Transmission Time Interval (TTI). For example, one subframe may be 1 ms in duration and one slot may be 0.5ms in duration. A slot includes a plurality of OFDM symbols in the time domain and a plurality of Resource Blocks (RBs) in the frequency domain. Because the 3GPP LTE system adopts OFDMA for downlink, an OFDM symbol represents one symbol period. An OFDM symbol may be referred to as an SC-FDMA symbol or symbol period. An RB is a resource allocation unit including a plurality of contiguous subcarriers in a slot.

The number of OFDM symbols in one slot may vary depending on a Cyclic Prefix (CP) configuration. There are two types of CPs: extended CP and normal CP. In the case of the normal CP, one slot includes 7 OFDM symbols. In the case of the extended CP, the length of one OFDM symbol is increased and thus the number of OFDM symbols in a slot is smaller than in the case of the normal CP. Thus when the extended CP is used, for example, 6 OFDM symbols may be included in one slot. If channel state gets poor, for example, during fast movement of a UE, the extended CP may be used to further decrease Inter-Symbol Interference (ISI).

In the case of the normal CP, one subframe includes 14 OFDM symbols because one slot includes 7 OFDM symbols. The first two or three OFDM symbols of each subframe may be allocated to a Physical Downlink Control CHannel (PDCCH) and the other OFDM symbols may be allocated to a Physical Downlink Shared Channel (PDSCH).

FIG. 1(b) illustrates the type-2 radio frame structure. A type-2 radio frame includes two half frames, each having 5 subframes, a Downlink Pilot Time Slot (DwPTS), a Guard Period (GP), and an Uplink Pilot Time Slot (UpPTS). Each subframe is divided into two slots. The DwPTS is used for initial cell search, synchronization, or channel estimation at a UE. The UpPTS is used for channel estimation and acquisition of uplink transmission synchronization to a UE at an eNB. The GP is a period between an uplink and a downlink, which eliminates uplink interference caused by multipath delay of a downlink signal. One subframe includes two slots irrespective of the type of a radio frame.

The above-described radio frame structures are purely exemplary and thus it is to be noted that the number of subframes in a radio frame, the number of slots in a subframe, or the number of symbols in a slot may vary.

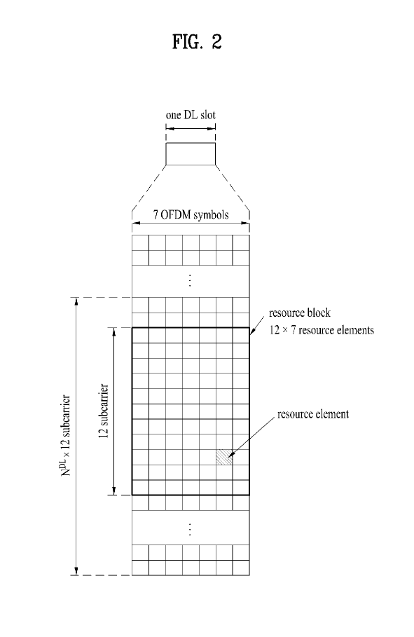

FIG. 2 illustrates the structure of a downlink resource grid for the duration of one downlink slot. A downlink slot includes 7 OFDM symbols in the time domain and an RB includes 12 subcarriers in the frequency domain, which does not limit the scope and spirit of the present invention. For example, a downlink slot may include 7 OFDM symbols in the case of the normal CP, whereas a downlink slot may include 6 OFDM symbols in the case of the extended CP. Each element of the resource grid is referred to as a Resource Element (RE). An RB includes 12×7 REs. The number of RBs in a downlink slot, NDL depends on a downlink transmission bandwidth. An uplink slot may have the same structure as a downlink slot.

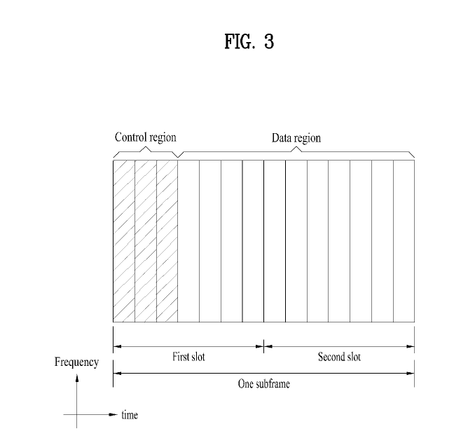

FIG. 3 illustrates the structure of a downlink subframe. Up to three OFDM symbols at the start of the first slot in a downlink subframe are used for a control region to which control channels are allocated and the other OFDM symbols of the downlink subframe are used for a data region to which a PDSCH is allocated. Downlink control channels used in the 3GPP LTE system include a Physical Control Format Indicator CHannel (PCFICH), a Physical Downlink Control CHannel (PDCCH), and a Physical Hybrid automatic repeat request (HARQ) Indicator CHannel (PHICH). The PCFICH is located in the first OFDM symbol of a subframe, carrying information about the number of OFDM symbols used for transmission of control channels in the subframe. The PHICH delivers an HARQ ACKnowledgment/Negative ACKnowledgment (ACK/NACK) signal in response to an uplink transmission. Control information carried on the PDCCH is called Downlink Control Information (DCI). The DCI transports uplink or downlink scheduling information, or uplink transmission power control commands for UE groups. The PDCCH delivers information about resource allocation and a transport format for a Downlink Shared CHannel (DL-SCH), resource allocation information about an Uplink Shared CHannel (UL-SCH), paging information of a Paging CHannel (PCH), system information on the DL-SCH, information about resource allocation for a higher-layer control message such as a Random Access Response transmitted on the PDSCH, a set of transmission power control commands for individual UEs of a UE group, transmission power control information, Voice Over Internet Protocol (VoIP) activation information, etc. A plurality of PDCCHs may be transmitted in the control region. A UE may monitor a plurality of PDCCHs. A PDCCH is formed by aggregating one or more consecutive Control Channel Elements (CCEs). A CCE is a logical allocation unit used to provide a PDCCH at a coding rate based on the state of a radio channel. A CCE includes a plurality of RE groups. The format of a PDCCH and the number of available bits for the PDCCH are determined according to the correlation between the number of CCEs and a coding rate provided by the CCEs. An eNB determines the PDCCH format according to DCI transmitted to a UE and adds a Cyclic Redundancy Check (CRC) to control information. The CRC is masked by an Identifier (ID) known as a Radio Network Temporary Identifier (RNTI) according to the owner or usage of the PDCCH. If the PDCCH is directed to a specific UE, its CRC may be masked by a cell-RNTI (C-RNTI) of the UE. If the PDCCH is for a paging message, the CRC of the PDCCH may be masked by a Paging Indicator Identifier (P-RNTI). If the PDCCH carries system information, particularly, a System Information Block (SIB), its CRC may be masked by a system information ID and a System Information RNTI (SI-RNTI). To indicate that the PDCCH carries a Random Access Response in response to a Random Access Preamble transmitted by a UE, its CRC may be masked by a Random Access-RNTI (RA-RNTI).

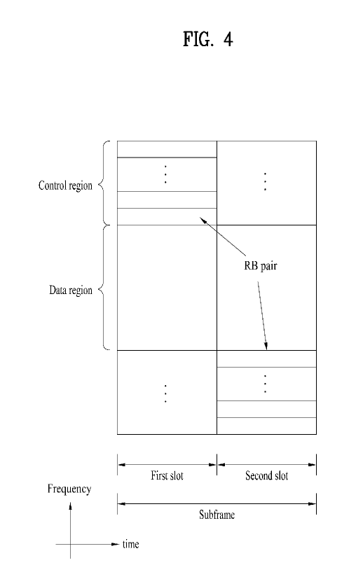

FIG. 4 illustrates the structure of an uplink subframe. An uplink subframe may be divided into a control region and a data region in the frequency domain. A Physical Uplink Control CHannel (PUCCH) carrying uplink control information is allocated to the control region and a Physical Uplink Shared Channel (PUSCH) carrying user data is allocated to the data region. To maintain the property of a single carrier, a UE does not transmit a PUSCH and a PUCCH simultaneously. A PUCCH for a UE is allocated to an RB pair in a subframe. The RBs of the RB pair occupy different subcarriers in two slots. Thus it is said that the RB pair allocated to the PUCCH is frequency-hopped over a slot boundary.

In the following, a PUCCH (physical uplink control channel) is explained.

Uplink control information (UCI) transmitted on PUCCH may include SR (Scheduling Request), HARQ ACK/NACK information, and DL channel measurement information.

The HARQ ACK/NACK information can be generated according to whether a decoding of a DL data packet on PDSCH is succeeded. In a legacy wireless communication system, 1 bit as the ACK/NACK information is transmitted for a DL single codeword transmission and 2 bits as the ACK/NACK information are transmitted for DL 2 codeword transmission.

The channel measurement information indicates feedback information related to a MIMO (Multiple Input Multiple Output) scheme and can include a channel quality indicator (CQI), a precoding matrix index (PMI), and a rank indicator (RI). The aforementioned channel measurement informations may be commonly called a CQI. 20 bits per subframe can be used to transmit the CQI.

PUCCH can be modulated using BPSK (binary phase shift keying) and QPSK (quadrature phase shift keying) scheme. Control information of a plurality of UEs can be transmitted on the PUCCH. In case of performing code division multiplexing (CDM) to distinguish a signal of each of the UEs, constant amplitude zero autocorrelation (CAZAC) sequence of length 12 is mainly used. Since the CAZAC sequence has a characteristic of maintaining constant amplitude in time domain and frequency domain, the CAZAC sequence has an appropriate property to increase coverage in a manner of lowering peak-to-average power ratio (PARR) or cubic metric (CM) of a UE. And, the ACK/NACK information on a DL data transmission transmitted on the PUCCH is covered using an orthogonal sequence or an orthogonal cover (OC).

And, the control information transmitted on the PUCCH can be distinguished using a cyclically shifted sequence including a cyclic shift (CS) value different from each other. The cyclically shifted sequence can be generated in a manner that a base sequence is cyclically shifted as much as a specific cyclic shift (CS) amount. The specific CS amount is indicated by a CS index. The number of available cyclic shift may vary according to a delay spread of a channel. Various types of sequences can be used as the base sequence and the aforementioned CAZAC sequence corresponds to one example of the base sequence.

And, the amount of control information capable of being transmitted by a UE in a subframe can be determined according to the number (i.e., SC-FDMA symbols except an SC-FDMA symbol used for transmitting a reference signal (RS) to detect coherent of the PUCCH) of SC-FDMA symbols capable of being used for transmitting the control information.

In 3GPP LTE system, PUCCH is defined by 7 different formats according to transmitted control information, a modulation scheme, the amount of control information, and the like. The attributes of transmitted uplink control information (UCI) can be summarized as Table 1 in the following according to each of the PUCCH formats.

TABLE 1

| PUCCH | Modulation | Number of bits | | |
|---|---|---|---|---|
| format | Scheme | per subframe | Usage | Etc. |
| 1 | N/A | N/A | SR | |
| | | | (Scheduling | |
| | | | Request) | |
| 1a | BPSK | 1 | ACK/NACK | One codeword |
| 1b | QPSK | 2 | ACK/NACK | Two codeword |
| 2 | QPSK | 20 | CQI | Joint Coding |
| | | | | ACK/NACK |
| | | | | (extended CP) |
| 2a | QPSK + | 21 | CQI + | Normal CP |
| | BPSK | | ACK/NACK | only |
| 2b | QPSK + | 22 | CQI + | Normal CP |
| | BPSK | | ACK/NACK | only |

PUCCH format 1 is used to solely transmit an SR. In case of solely transmitting the SR, a wave, which is not modulated, is applied. This shall be described in detail later.

PUCCH format 1a or 1b is used to transmit HARQ ACK/NACK. In case of solely transmitting the HARQ ACK/NACK in a random subframe, the PUCCH format 1a or 1b can be used. Or, the HARQ ACK/NACK and the SR may be transmitted in an identical subframe using the PUCCH format 1a or 1b.

PUCCH format 2 is used to transmit a CQI and PUCCH format 2a or 2b is used to transmit the CQI and the HARQ ACK/NACK. In case of an extended CP, the PUCCH format 2 may be used to transmit the CQI and the HARQ ACK/NACK.

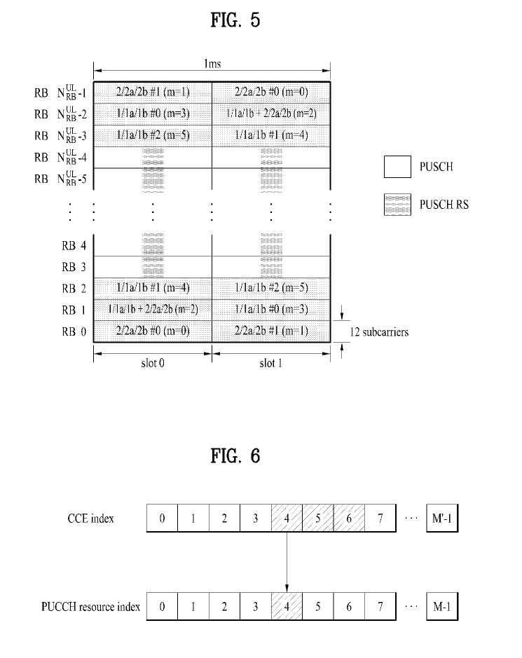

FIG. 5 is a diagram of a form that PUCCH formats map to PUCCH regions in an uplink physical resource block. Referring to FIG. 5, N_{RB}^{UL} indicates the number of resource blocks in UL and 0, 1, . . . N_{RB}^{UL}-1 means numbers of the physical resource block. Basically, PUCCH is mapped to both edges of a UL frequency block. As depicted in FIG. 5, PUCCH format 2/2a/2b are mapped to the PUCCH region displayed as m=0, 1. This may represent that the PUCCH format 2/2a/2b are mapped to resource blocks situated at a band-edge. And, the PUCCH format 2/2a/2b and PUCCH format 1/1a/1b can be mapped to a PUCCH region displayed as m=2 in a manner of being mixed. The PUCCH format 1/1a/1b can be mapped to a PUCCH region displayed as m=3, 4, 5. The number (N_{RB}⁽²⁾) of PUCCH RBs usable by the PUCCH format 2/2a/2b can be directed to UEs in a cell by a broadcasting signaling.

In the following, a PUCCH resource is explained.

A base station (BS) assigns a PUCCH resource for transmitting uplink control information (UCI) to a UE by an explicit scheme via a higher layer signaling or an implicit scheme.

In case of ACK/NACK, a plurality of PUCCH resource candidates can be configured to a UE by a higher layer and which PUCCH resource is used among a plurality of the PUCCH resource candidates can be determined by the implicit scheme. For instance, the UE receives PDSCH from the BS and the ACK/NACK for a corresponding data unit can be transmitted via the PUCCH resource implicitly determined by PDCCH resource carrying scheduling information on the PDSCH.

FIG. 6 is a diagram for an example of determining a PUCCH resource for ACK/NACK.

In LTE system, a PUCCH resource for the ACK/NACK is not assigned to each UE in advance. Instead, a plurality of UEs belonging to a cell use a plurality of PUCCH resources on every timing point in a manner of dividing a plurality of the PUCCH resources. Specifically, the PUCCH resource used for transmitting the ACK/NACK by the UE is determined by an implicit scheme based on the PDCCH carrying scheduling information on PDSCH, which carries a corresponding DL data. A whole region to which the PDCCH is transmitted in each DL subframe consists of a plurality of control channel elements (CCE). And, the PDCCH transmitted to the UE consists of one or more CCEs. The CCE includes a plurality of REGs (resource element group) (e.g., 9 REGs). One REG consists of 4 adjacent REs (resource element) except a reference signal (RS). The UE transmits the ACK/NACK via an implicit resource derived or calculated by a function of a specific CCE index (e.g., a first or a lowest CCE index) among the indexes of CCEs that construct the PDCCH received by the UE.

Referring to FIG. 6, each of the PUCCH resource indexes corresponds to the PUCCH resource for the ACK/NACK. If it is assumed that scheduling information on PDSCH is transmitted to a UE via PDCCH configured with 4^{th}˜6^{th} CCEs, the UE transmits the ACK/NACK to the BS via PUCCH, e.g., 4^{th} PUCCH, derived or calculated from the index of the 4^{th} CCE, which is the lowest CCE for configuring the PDCCH. FIG. 6 shows an example that maximum M′ number of CCEs exist in DL and maximum M number of PUCCHs exist in UL. Although the M′ and the M may be identical to each other, it is also possible to design a value of the M′ to be different from a value of the M. And, it is also able to make the mapping of the CCE to be overlapped with the mapping of the PUCCH resource.

For instance, the PUCCH resource index can be determined as follows.

n_{PUCCH}⁽¹⁾=n_{CCE}+N_{PUCCH}⁽¹⁾ [Equation 1]

In this case, n_{PUCCH}⁽¹⁾ indicates a PUCCH resource index for transmitting the ACK/NACK and N_{PUCCH}⁽¹⁾ indicates a signaling value delivered from a upper layer. The n_{CCE} may indicate a smallest value among the CCE indexes used for PDCCH transmission.

In the following, a PUCCH channel structure is explained.

First of all, PUCCH format 1a and 1b are explained.

In the PUCCH format 1a/1b, a symbol modulated using the BPSK or QPSK modulation scheme is multiplied by a CAZAC sequence of length 12. For instance, a result of multiplying a modulated symbol d(0) by a CAZAC sequence r(n) of length N corresponds to y(0), y(1), y(2), . . . , y(N-1). The y(0), . . . , the y(N-1) symbols may be called a symbol block (block of symbol). After a modulated symbol is multiplied by a CAZAC sequence, a block-wise spreading using an orthogonal sequence is applied.

Aa Hadamard sequence of length 4 is used for normal ACK/NACK information. A Discrete Fourier Transform (DFT) sequence of length 3 is used for shortened ACK/NACK information and a reference signal. A Hadamard sequence of length 2 is used for a reference signal in case of an extended CP.

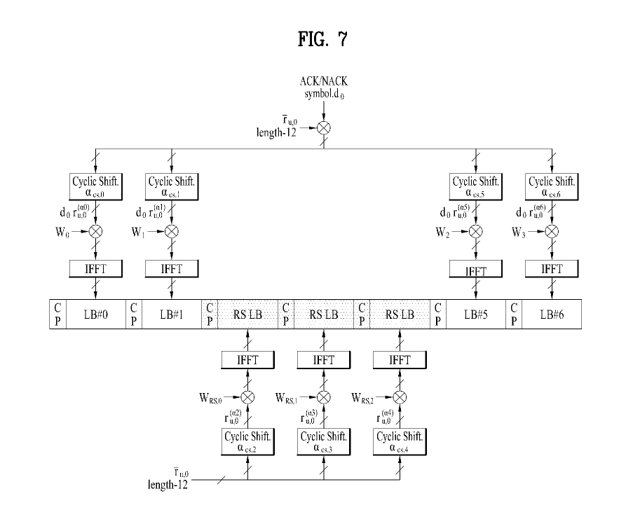

FIG. 7 is a diagram for a structure of an ACK/NACK channel in case of a normal CP. A PUCCH channel structure to transmit HARQ ACK/NACK without a CQI is exemplified in FIG. 7. Among the 7 SC-FDMA symbols included in one slot, three consecutive SC-FDMA symbols in the middle part of the slot load a reference signal (RS) and the rest of 4 SC-FDMA symbols load an ACK/NACK signal. Meanwhile, in case of an extended CP, two consecutive symbols situated in the middle may load the RS. The number of symbols and the positions of the symbols used for the RS may vary according to a control channel And, the number of symbols and the positions of the symbols used for the ACK/NACK signal may vary according to the control channel as well.

Confirmation response information (in a state of not scrambled) of 1 bit and 2 bits can be represented by one HARQ ACK/NACK modulated symbol using BPSK and QPSK modulation scheme, respectively. A positive confirmation response (ACK) can be encoded by ‘1’ and a negative confirmation response (NACK) can be encoded by ‘0’.

When a control signal is transmitted in an assigned band, 2 dimensional spread is applied to increase a multiplexing capacity. In particular, frequency domain spread and time domain spread are simultaneously applied to increase the number of UEs and the number of control channels capable of being multiplexed. In order to spread the ACK/NACK signal in frequency domain, a frequency domain sequence is used as a base sequence. As the frequency domain sequence, a Zadoff-Chu (ZC) sequence, which is one of the CAZAC sequences, can be used. For instance, by applying a different cyclic shift (CS) to the ZC sequence, which is the base sequence, multiplexing of UEs different from each other or multiplexing of control channels different from each other can be applied. The number of CS resources, which are supported in a SC-FDMA symbol for PUCCH RBs for transmitting HARQ ACK/NACK, is configured by a cell-specific upper layer signaling parameter (Δ_{shift}^{PUCCH}) and Δ_{shift}^{PUCCH}∈}1, 2, 3} indicates 12, 6, or 4 shift, respectively.

A frequency domain spread ACK/NACK signal is spread in time domain using an orthogonal spreading code. As the orthogonal spreading code, a Walsh-Hadamard sequence or a DFT sequence can be used. For instance, an ACK/NACK signal can be spread to 4 symbols using an orthogonal sequence (w0, w1, w2, w3) of length 4. And, an RS is also spread using an orthogonal sequence of length 3 or length 2. This is called an orthogonal covering (OC).

As mentioned in the foregoing description, a plurality of UEs can be multiplexed by a code division multiplexing (CDM) scheme using a CS resource in frequency domain and an OC resource in time domain. In particular, the ACK/NACK information and the RS of a plurality of the UEs can be multiplexed in the same PUCCH RB.

When the aforementioned time domain spread CDM is performed, the number of spreading codes supporting the ACK/NACK information is restricted by the number of RS symbols. In particular, since the number of SC-FDMA symbols transmitting the RS is less than the number of SC-FDMA symbols transmitting the ACK/NACK information, multiplexing capacity of the RS is smaller than the multiplexing capacity of the ACK/NACK information. For instance, in case of a normal CP, the ACK/NACK information can be transmitted in four symbols. In this case, not four orthogonal spreading codes but three orthogonal spreading codes are used for the ACK/NACK information. This is because, since the number of symbols transmitting the RS is restricted to three, three orthogonal spreading codes are used for the RS only.

An example of the orthogonal sequence used for the spread of the ACK/NACK information is shown in Table 2 and Table 3. Table 2 indicates a sequence for a symbol of length 4 and Table 3 indicates a sequence for a symbol of length 3. The sequence for the symbol of length 4 is used in PUCCH format 1/1a/1b of a normal subframe configuration. In case of configuring a subframe, the sequence for the symbol of length 4 is applied in a first slot and a shortened PUCCH format 1/1a/1b of the sequence for the symbol of length 3 can be applied in a second slot in consideration of a case that a sounding reference signal (SRS) is transmitted in a last symbol of the second slot.

In Table s 2 and 3, a sequence index can be represented by n_{oc}^{(p̅)}(nₛ).

TABLE 2

| Sequence index | Orthogonal sequences [w(0) . . . w (N_{SF}^{PUCCH} − 1)] | | | |
|---|---|---|---|---|
| 0 | [ +1 | +1 | +1 | +1 ] |
| 1 | [ +1 | −1 | +1 | −1 ] |
| 2 | [ +1 | −1 | −1 | +1 ] |

TABLE 3

| Sequence index | Orthogonal sequences [w(0) . . . w (N_{SF}^{PUCCH} − 1)] | | |
|---|---|---|---|
| 0 | [ 1 | 1 | 1] |
| 1 | [ 1 | e^{j2π/3} | e^{j4π/3} ] |
| 2 | [ 1 | e^{j4π/3} | e^{j2π/3} ] |

In case that 3 symbols are used for RS transmission and 4 symbols are used for ACK/NACK information transmission in a slot of a subframe of a normal CP, for instance, if 6 cyclic shifts (CS) in frequency domain and 3 orthogonal cover (OC) resources in time domain are available, HARQ confirmation responses received from 18 different UEs in total can be multiplexed in one PUCCH RB. In case that 2 symbols are used for RS transmission and 4 symbols are used for ACK/NACK information transmission in a slot of a subframe of an extended CP, for instance, if 6 cyclic shifts (CS) in frequency domain and 2 orthogonal cover (OC) resources in time domain are available, HARQ confirmation responses received from 12 different UEs in total can be multiplexed in one PUCCH RB.

Subsequently, PUCCH format 1 is explained. A scheduling request (SR) is transmitted in a manner that a UE makes a request to be scheduled or the UE does not make a request to be scheduled. An SR channel reuses an ACK/NACK channel structure of a PUCCH format 1a/1b and is configured with an on-off keying (OOK) scheme based on an ACK/NACK channel design. A reference signal is not transmitted on the SR channel Hence, a sequence of length 7 is used in case of a normal CP and a sequence of length 6 is used in case of an extended CP. A different cyclic shift or an orthogonal cover can be assigned to an SR and an ACK/NACK. In particular, a UE transmits a HARQ ACK/NACK via a resource allocated for an SR to transmit a positive SR. The UE transmits the HARQ ACK/NACK via a resource allocated for an ACK/NACK to transmit a negative SR.

Subsequently, PUCCH format 2/2a/2b is explained. The PUCCH format 2/2a/2b is a control channel to transmit a channel measurement feedback (CQI, PMI, RI).

A reporting cycle of the channel measurement feedback (hereinafter, commonly referred to as CQI information) and a frequency unit (or a frequency resolution), which becomes a measurement target, can be controlled by a base station. A periodic and an aperiodic CQI report can be supported in time domain. A PUCCH format 2 is used for the periodic report only and PUSCH can be used for the aperiodic report. In case of the aperiodic report, a base station can indicate a UE to transmit a scheduled resource in a manner of loading a separate CQI report on the scheduled resource to transmit a UL data.

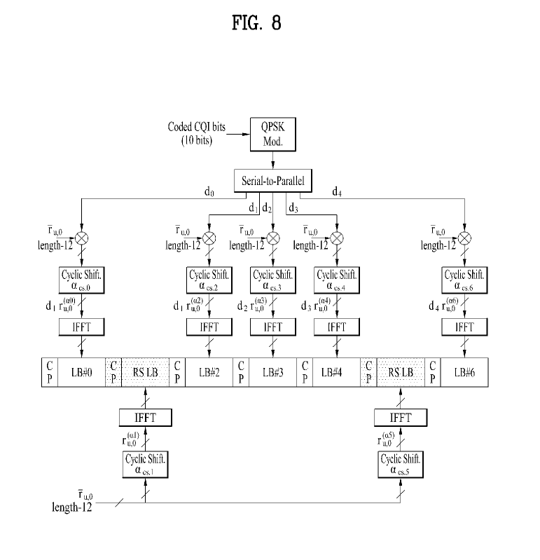

FIG. 8 is a diagram for a structure of a CQI channel in case of a normal CP. Among FDMA symbol 0 to 6 in one slot, SC-FDMA symbols 1 and 5 (i.e., second and sixth symbol) are used to transmit a demodulation reference signal (DMRS) and the rest of the SC-FDMA symbols are used to transmit CQI information. Meanwhile, in case of an extended CP, one SC-FDMA symbol (i.e., SC-FDMA symbol 3) is used to transmit a DMRS.

PUCCH format 2/2a/2b supports a modulation performed by a CAZAC sequence and a symbol modulated by QPSK scheme is multiplied by a CAZAC sequence of length 12. A cyclic shift (CS) of a sequence is modified between a symbol and a slot. An orthogonal covering is used for a DMRS.

Among the 7 SC-FDMA symbols included in one slot, a reference signal (DMRS) is loaded on 2 SC-FDMA symbols apart from as much as a space of 3 SC-FDMA symbols and CQI information is loaded on the rest of the 5 SC-FDMA symbols. Using two RSs in one slot is to support a fast UE. And, each UE is distinguished using a cyclic shift (CS) sequence. CQI information symbols are delivered to all SC-FDMA symbols in a manner of being modulated and an SC-FDMA symbol is configured with one sequence. In particular, a UE transmits a CQI to each sequence in a manner of modulating the CQI.

The number of symbols capable of being transmitted in one TTI corresponds to 10 and a modulation scheme of CQI information is determined up to QPSK. In case of using QPSK mapping for an SC-FDMA symbol, since a CQI value of 2-bit can be loaded, the CQI value of 10-bit can be loaded in one slot. Hence, the CQI value of maximum 20 bits can be loaded in one subframe. A frequency domain spreading code is used to spread the CQI information in frequency domain.

A CAZAC sequence (e.g., a ZC sequence) of length-12 can be used as the frequency domain spreading code. Each control channel can be distinguished by applying the CAZAC sequence including a different cyclic shift value. An IFFT is performed on the frequency domain spread CQI information.

12 different UEs can be orthogonally multiplexed in an identical PUCCH RB by a cyclic shift including 12 same intervals. In case of a normal CP, a DMRS sequence on the SC-FDMA symbols 1 and 5 (in case of an extended CP, SC-FDMA symbol 3) is similar to a CQI signal sequence in frequency domain. Yet, a modulation applied to the CQI information is not applied to the DMRS sequence. A UE can be semi-statically configured by an upper layer signaling to periodically report different types of CQI, PMI and RI on a PUCCH resource indicated by a PUCCH resource index (n_{PUCCH}⁽²⁾). In this case, the PUCCH resource index (n_{PUCCH}⁽²⁾) corresponds to information indicating a PUCCH region used for PUCCH format 2/2a/2b transmission and a cyclic shift (CS) value to be used.

Subsequently, an enhanced-PUCCH (e-PUCCH) format is explained. The e-PDCCH may correspond to a PUCCH format 3 of LTE-A system. A block spreading scheme can be applied to an ACK/NACK transmission using the PUCCH format 3.

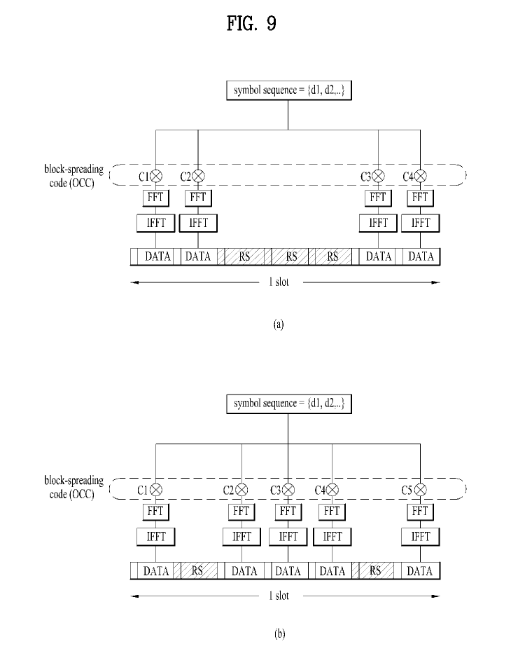

Unlike a legacy PUCCH format 1 series or 2 series, the block spreading scheme is a scheme for modulating a control signal transmission using an SC-FDMA scheme. As shown in FIG. 9, a symbol sequence can be transmitted in time domain in a manner of being spread using an orthogonal cover code (OCC). By using the OCC, control signals of a plurality of UEs can be multiplexed in an identical RB. In case of the aforementioned PUCCH format 2, one symbol sequence is transmitted over time domain and the control signals of a plurality of the UEs are multiplexed using the CS (cyclic shift) of the CAZAC sequence. On the other hand, in case of the block spreading-based PUCCH format (e.g., PUCCH format 3), one symbol sequence is transmitted over frequency domain and the control signals of a plurality of the UEs are multiplexed by using time domain spreading using the OCC.

FIG. 9(a) shows an example that 4 SC-FDMA symbols (i.e., data part) are generated using an OCC of length 4 (or, a spreading factor (SF)=4) in one symbol sequence and are transmitted in one slot. In this case, 3 RS symbols (i.e., RS part) can be used in one slot.

FIG. 9(b) shows an example that 5 SC-FDMA symbols (i.e., data part) are generated using an OCC of length 5 (or a spreading factor (SF)=5) in one symbol sequence and are transmitted in one slot. In this case, 2 RS symbols can be used in one slot.

Referring to the example shown in FIG. 9, the RS symbol can be generated from a CAZAC sequence to which a specific cyclic shift value is applied and can be transmitted in a manner that a prescribed OCC is applied (or multiplied) to a plurality of RS symbols. And, in the example of FIG. 9, if it is assumed that 12 modulation symbols are used according to each OFDM symbol (or SC-FDMA symbol) and each modulation symbol is generated by QPSK scheme, the maximum number of bits capable of being transmitted in one slot becomes 12*2=24 bits. Hence, the number of bits capable of being transmitted in 2 slots becomes 48 bits in total. As mentioned earlier, in case of using the PUCCH channel structure of the block spreading scheme, it is able to transmit control information of an extended size compared to a size of a legacy PDCCH format 1 series and 2 series.

In the following, ACK/NACK multiplexing method is explained.

In case of ACK/NACK multiplexing, ACK/NACK response contents on a plurality of data units can be identified by a combination of an ACK/NACK unit used for practically transmitting an ACK/NACK and symbols modulated by QPSK scheme. For instance, assume that one ACK/NACK unit carries information of 2-bit long and receives maximum 2 data units. In this case, assume that a HARQ confirmation response for each of the received data units is represented by one ACK/NACK bit. In this case, a transmitting end, which has transmitted a data, can identify such ACK/NACK results as shown in Table 4 described in the following.

TABLE 4

| HARQ-ACK(0), | | b(0), |
|---|---|---|
| HARQ-ACK(1) | n⁽¹⁾_{PUCCH} | b(1) |
| ACK, ACK | n⁽¹⁾_{PUCCH, 1} | 1, 1 |
| ACK, NACK/DTX | n⁽¹⁾_{PUCCH, 0} | 0, 1 |
| NACK/DTX, ACK | n⁽¹⁾_{PUCCH, 1} | 0, 0 |
| NACK/DTX, NACK | n⁽¹⁾_{PUCCH, 1} | 1, 0 |
| NACK, DTX | n⁽¹⁾_{PUCCH, 0} | 1, 0 |
| DTX, DTX | N/A | N/A |

Referring to Table 4, HARQ-ACK(i) (i=0, 1) indicates the ACK/NACK result for a data unit i. As mentioned earlier, since it is assumed that the maximum 2 data units (data unit 0 and data unit 1) are received, ACK/NACK result for the data unit 0 is represented as HARQ-ACK(0) and the ACK/NACK result for the data unit 1 is represented as HARQ-ACK(1) in the Table 4. In the Table 4, discontinuous transmission (DTX) indicates that a data unit corresponding to the HARQ-ACK(i) is not transmitted or a receiving end cannot detect a presence of a data unit corresponding to the HARQ-ACK(i). And, n_{PUCCH,x}⁽¹⁾ indicates an ACK/NACK unit practically used for an ACK/NACK transmission. In case that maximum two ACK/NACK units exist, the ACK/NACK unit can be represented as n_{PUCCH,0}⁽¹⁾ and n_{PUCCH,1}⁽¹⁾. And, b(0) and b(1) indicate two bits transmitted by a selected ACK/NACK unit. A modulation symbol transmitted through the ACK/NACK unit is determined according to the b(0) and the b(1) bit.

For instance, if a receiving end successfully receives and decodes two data units (i.e., in case of ACK, ACK in the Table 4), the receiving end transmits two bits (1, 1) using the ACK/NACK unit n_{PUCCH,1}⁽¹⁾. Or, when the receiving end receives two data units, if the receiving end fails to decode (detect) a first data unit (i.e., data unit 0 corresponding to HARQ(0)) and successfully decodes a second data unit (i.e., data unit 1 corresponding to HARQ-ACK(1)) (i.e., in case of NACK/DTX, ACK in the Table 4), the receiving end transmits 2 bits (0, 0) using the ACK/NACK unit n_{PUCCH,1}⁽¹⁾.

As mentioned in the foregoing description, the ACK/NACK information on a plurality of the data units can be transmitted using one ACK/NACK unit in a manner of linking or mapping a combination (i.e., combination of selecting either n_{PUCCH,0}⁽¹⁾ or n_{PUCCH,1}⁽¹⁾ and b(0), b(1)) of a selection of the ACK/NACK unit and an actual bit content of a transmitted ACK/NACK unit to actual ACK/NACK contents. The ACK/NACK multiplexing for the data units greater than two data units can be easily implemented by extending a principle of the aforementioned ACK/NACK multiplexing as it is.

In the aforementioned ACK/NACK multiplexing scheme, if at least one ACK basically exists for all data units, an NACK may be not distinguished from a DTX (in particular, as represented as NACK/DTX in Table 4, the NACK and the DTX can be coupled). This is because all ACK/NACK states (i.e. ACK/NACK hypotheses) capable of being occurred in case of separately representing the NACK and the DTX cannot be reflected by a combination of the ACK/NACK unit and the symbol modulated by QPSK scheme only. Meanwhile, if the ACK does not exist in all data units (i.e., if the NACK or the DTX exists only in all data units), it may define one definite NACK indicating one definite NACK (i.e., an NACK distinguished from a DTX) among the HARQ-ACKs(i). In this case, an ACK/NACK unit corresponding to a data unit indicating the definite NACK can be reserved to transmit signals of a plurality of ACKs/NACKs.

In the following, PUCCH piggyback is explained.

In case of an uplink transmission of a legacy 3GPP LTE system (e.g., release-8), a single carrier transmission of a good PAPR (peak-to-average power ratio) or a good CM (cubic metric) influencing on the performance of a power amp is maintained to efficiently utilize the power amp of a UE. In particular, in case of a PUSCH transmission of a legacy LTE system, a single carrier property of a data to be transmitted is maintained by a DFT-precoding. In case of a PUCCH transmission, the single carrier property can be maintained by transmitting a sequence having the single carrier property in a manner of loading information on the sequence. Yet, in case of non-contiguously assigning a DFT-precoded data to a frequency axis or in case of simultaneously transmitting PUSCH and PUCCH, the single carrier property is not maintained.

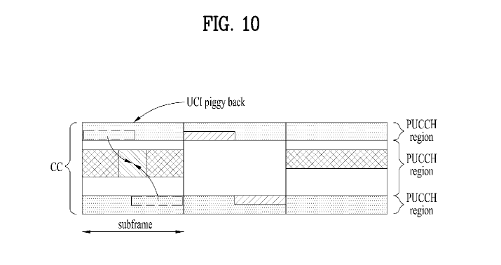

Hence, as depicted in FIG. 10, in case of performing PUSCH transmission and PUCCH transmission in the same subframe, UCI (uplink control information) supposed to be transmitted on PUCCH is transmitted (piggyback) on PUSCH together with a data to maintain the single carrier property.

As mentioned in the foregoing description, since a legacy LTE UE is unable to transmit PUCCH and PUSCH at the same time, a method of multiplexing the UCI (CQI/PMI, HARQ-ACK, RI, and the like) in the PUSCH region is used in a subframe in which the PUSCH is transmitted. For example, if it is necessary to transmit CQI and/or PMI in the subframe in which the PUSCH is transmitted, control information and a data can be transmitted together by multiplexing UL-SCH data and the CQI/PMI prior to a DFT-spreading. In this case, the UL-SCH data performs a rate-matching in consideration of a CQI/PMI resource. And, such control information as a HARQ ACK, an RI, and the like can be multiplexed in the PUSCH region by puncturing the UL-SCH data.

In the following, an RS (reference signal) is explained.

In a wireless communication system, a Packet is transmitted on a radio channel. In view of the nature of the radio channel, the Packet may be distorted during the transmission. To receive the signal successfully, a receiver should compensate for the distortion of the received signal using channel information. Generally, to enable the receiver to acquire the channel information, a transmitter transmits a signal known to both the transmitter and the receiver and the receiver acquires knowledge of channel information based on the distortion of the signal received on the radio channel This signal is called a pilot signal or an RS.

In the case of data transmission and reception through multiple antennas, knowledge of channel states between Transmission (Tx) antennas and Reception (Rx) antennas is required for successful signal reception. Accordingly, an RS should be transmitted through each Tx antenna (i.e. antenna port).

RSs may be divided into downlink RSs and uplink RSs. In the current LTE system, the uplink RSs include:

i) DeModulation-Reference Signal (DM-RS) used for channel estimation for coherent demodulation of information delivered on a PUSCH and a PUCCH; and

ii) Sounding Reference Signal (SRS) used for an eNB or a network to measure the quality of an uplink channel in a different frequency.

The downlink RSs are categorized into:

i) Cell-specific Reference Signal (CRS) shared among all UEs of a cell;

ii) UE-specific RS dedicated to a specific UE;

iii) DM-RS used for coherent demodulation of a PDSCH, when the PDSCH is transmitted;

iv) Channel State Information-Reference Signal (CSI-RS) carrying CSI, when downlink DM-RSs are transmitted;

v) Multimedia Broadcast Single Frequency Network (MBSFN) RS used for coherent demodulation of a signal transmitted in MBSFN mode; and

vi) positioning RS used to estimate geographical position information about a UE.

RSs may also be divided into two types according to their purposes: RS for channel information acquisition and RS for data demodulation. Since its purpose lies in that a UE acquires downlink channel information, the former should be transmitted in a broad band and received even by a UE that does not receive downlink data in a specific subframe. This RS is also used in a situation like handover. The latter is an RS that an eNB transmits along with downlink data in specific resources. A UE can demodulate the data by measuring a channel using the RS. This RS should be transmitted in a data transmission area.

CRSs serve two purposes, that is, channel information acquisition and data demodulation. A UE-specific RS is used only for data demodulation. CRSs are transmitted in every subframe in a broad band and CRSs for up to four antenna ports are transmitted according to the number of Tx antennas in an eNB.

For example, if the eNB has two Tx antennas, CRSs for antenna ports 0 and 1 are transmitted. In the case of four Tx antennas, CRSs for antenna ports 0 to 3 are respectively transmitted.

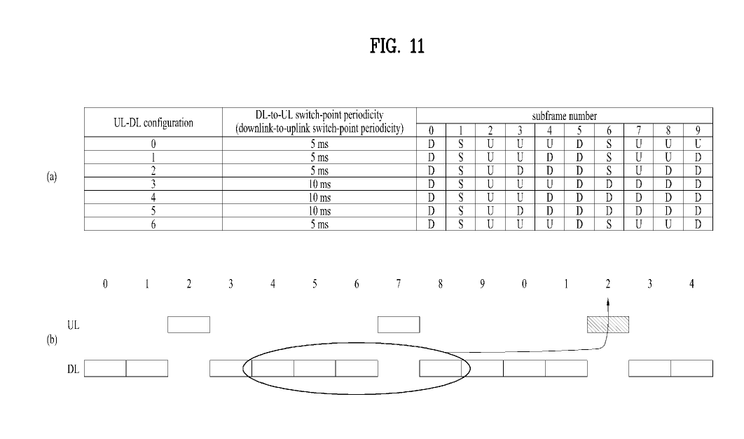

FIG. 11 illustrates patterns in which CRSs and DRSs are mapped to a downlink RB pair, as defined in a legacy 3GPP LTE system (e.g. conforming to Release-8). An RS mapping unit, i.e. a downlink RB pair may include one subframe in time by 12 subcarriers in frequency. That is, an RB pair includes 14 OFDM symbols in time in the case of the normal CP (see FIGS. 11(a)) and 12 01-DM symbols in time in the case of the extended CP (see FIG. 11(b)).

In FIG. 11, the positions of RSs in an RB pair for a system where an eNB supports four Tx antennas are illustrated. Resource elements (REs) represented by reference numerals 0, 1, 2 and 3 denote positions of CRSs for antenna port 0 to antenna port 3, respectively, and a resource element represented by reference character ‘D’ denotes the positions of DRMSs.

In the following, Enhanced-PDCCH (EPDCCH) is explained.

In LTE system appearing after release 11, in order to solve a PDCCH capacity deficiency problem caused by CoMP (coordinate multi point), MU-MIMO (multi user-multiple input multiple output) and the like and a PDCCH performance degradation problem due to inter-cell interference, it is considering the use of enhanced-PDCCH (EPDCCH) capable of being transmitted via a legacy PDSCH region. And, unlike a legacy CRS-based PDCCH, the EPDCCH can perform channel estimation based on a DMRS to obtain a pre-coding gain and the like.

EPDCCH transmission can be divided into localized EPDCCH transmission and distributed EPDCCH transmission according to a configuration of PRB (physical resource block) pair used for transmitting EPDCCH. The localized EPDCCH transmission indicates a case that ECCE for transmitting single DCI is adjacent to each other in frequency domain and a specific precoding can be applied to obtain beamforming gain. For instance, the localized EPDCCH transmission can be performed based on contiguous ECCEs of a number corresponding to an aggregation level. On the contrary, the distributed EPDCH transmission may indicate a case that a single EPDCCH is transmitted in a PRB pair separated from each other in frequency domain and can obtain a gain in terms of frequency diversity. For instance, the distributed EPDCCH transmission can be performed based on ECCE consisting of 4 EREGs, which are respectively included in a PRB pair separated from each other in frequency domain. One or two EPDCCH (PRB) sets can be configured to a terminal via upper layer signaling and the like and each of the EPDCCH PRB sets can be used for either the localized EPDCCH transmission or the distributed EPDCCH transmission.

In order for a terminal to receive/obtain control information (DCI) via EPDCCH, similar to a legacy LTE/LTE-A system, the terminal is able to perform blind decoding. More specifically, the terminal may attempt (monitoring) to decode EPDCCH candidate set according to an aggregation level for DCI formats corresponding to a configured transmission mode. In this case, the EPDCCH candidate set becoming a target of the monitoring can be referred to as an EPDCCH UE-specific search space and the search space can be configured according to an aggregation level. And, somewhat different from the aforementioned legacy LTE/LTE-A, the aggregation level may become {1, 2, 4, 8, 16 and 32} according to a subframe type, a CP length, an available resource amount in a PRB pair and the like.

In case of a terminal to which EPDCCH is configured, REs included in a PRB pair set are indexed by an EREG and the EREG can be indexed again in an ECCE unit. An EPDCCH candidate configuring a search space is determined and blind decoding is performed based on the indexed ECCE to receive control information. In this case, the EREG and the ECCE correspond to the REG and the CCE, respectively, in the legacy LTE/LTE-A. One PRB pair can include 16 EREGs.

In the following, transmission of EPDCCH and reception confirmation response is explained in detail.

Having received EPDCCH, a terminal can transmit a reception confirmation response (ACK/NACK/DTX) on PUCCH in response to the EPDCCH. In this case, similar to the aforementioned Equation 1, a resource being used, i.e., an index of a PUCCH resource, can be determined by a lowest ECCE index among ECCEs used for transmitting the EPDCCH. In particular, it may be able to be represented as Equation 2 in the following.

n_{PUCCH-ECCE}⁽¹⁾=n_{ECCE}+N_{PUCCH}⁽¹⁾ [Equation 2]

In Equation 2, n_{PUCCH-ECCE}⁽¹⁾ indicates the PUCCH resource index, n_{ECCE} indicates the lowest ECCE index among ECCEs used for transmitting the EPDCCH, and N_{PUCCH}⁽¹⁾ (also represented as N_{PUCCH ,EPDCCH}⁽¹⁾) indicates a value delivered via upper layer signaling and a point where the PUCCH resource index starts.

Yet, if PUCCH resource indexes are uniformly determined by the aforementioned Equation 2, a resource collision problem may occur. For instance, in case of configuring two EPDCCH PRB sets, since ECCE indexing is independently performed in each of the EPDCCH PRB sets, a lowest ECCE index in each of the EPDCCH PRB sets may be identical to each other. In this case, if a start point of a PUCCH resource is differentiated according to a user, a problem may be solved. Yet, if the start point of the PUCCH resource is differentiated according to all users, since it is to reserve a huge amount of PUCCH resources, it is inefficient. And, similar to MU-MIMO, since DCI of many users can be transmitted at the same ECCE position in EPDCCH, it is necessary to have a method of allocating a PUCCH resource in consideration of the aforementioned cases. In order to solve the aforementioned problem, ARO (HARQ-ACK resource offset) has been introduced. The ARO shifts a lowest ECCE index among ECCE indexes configuring EPDCCH and a PUCCH resource determined by a start offset of a PUCCH resource delivered via upper layer signaling to avoid collision of PUCCH resources. The ARO is indicated by 2 bits of DCI formats 1A/1B/1D/1/2A/2/2B/2C/2D transmitted on EPDCCH as shown in Table 5 in the following.

TABLE 5

| ACK/NACK Resource | |
|---|---|
| offset field in DCI format | |
| 1A/1B/1D/1/2A/2/2B/2C/2D | Δ_{ARO} |
| 0 | 0 |
| 1 | −1 |
| 2 | −2 |
| 3 | 2 |

A base station selects a value from among ARO values shown in Table 5 for a specific terminal and may be then able to inform the specific terminal of the ARO for determining a PUCCH resource via a DCI format. The terminal detects an ARO field in a DCI format of the terminal and may be able to transmit a reception confirmation response via a PUCCH resource which is determined using a value of the ARQ field.

Meanwhile, unlike a case of FDD, since uplink(UL) and downlink (DL) are not separated from each other in TDD, it may be able to transmit reception confirmation responses for a plurality of downlink subframes (of PDSCH) in a single uplink subframe. Regarding this, it shall be explained with reference to FIG. 11 in the following. FIG. 11(a) shows UL-DL configuration used in TDD and FIG. 11(b) shows a reception confirmation response in case of a UL-DL configuration 2. Referring to FIG. 11, in case of the TDD UL-DL configuration 2, subframes usable for UL are restricted to a 2^{nd} subframe and a 7^{th} subframe. Hence, it is necessary to transmit reception confirmation response for 8 DL subframes (including a special subframe) via the 2 UL subframes (the 2^{nd} subframe and the 7^{th} subframe). To this end, a DL association set index shown in Table 6 is defined.

TABLE 6

| UL-DL | Subframe n | | | | | | | | | |
|---|---|---|---|---|---|---|---|---|---|---|
| configuration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, 4, 6 | — | — | — | — | 8, 7, 4, 6 | — | — |
| 3 | — | — | 7, 6, 11 | 6, 5 | 5, 4 | — | — | — | — | — |
| 4 | — | — | 12, 8, 7, 11 | 6, 5, 4, 7 | — | — | — | — | — | — |
| 5 | — | — | 13, 12, 9, 8, 7, 5, 4, | — | — | — | — | — | — | — |
| | | | 11, 6 | | | | | | | |
| 6 | — | — | 7 | 7 | 5 | — | — | 7 | 7 | — |

A DL association set K includes elements of {k₀, k₁, . . . , k_{M-1}} in each UL subframe. An M (bundling window size) corresponds to the number of DL subframes in which a reception confirmation response is transmitted in the DL association set K. In Table 6, each number indicates a distance between a previous DL subframe and a current UL subframe. For instance, in case of the UL-DL configuration 2, as shown in FIG. 11(b), a second subframe transmits a reception confirmation response of subframes (4^{th}, 5^{th}, 8^{th} and 6^{th} subframes of a previous radio frame) preceding as many as 8, 7, 4 and 6subframes from the second subframe.

In order to transmit reception confirmation response for a plurality of DL subframes in a UL subframe, it may be able to use a resource allocation scheme in a form of sequentially attaching PUCCH resources according to an order of the association set in accordance with an EPDCCH PRB set. For instance, in case of UL-DL configuration 5, a PUCCH resource area is reserved for subframes corresponding to an association set {13, 12, 9, 8, 7, 5, 4, 11, 6} in a 2^{nd} subframe in response to EPDCCH-PRB set j.

However, if a PUCCH resource area is reserved for each of a plurality of DL subframes in a UL subframe, it may cause waste of PUCCH resources. Hence, in order to efficiently use the PUCCH resources, a large value offset has been introduced in TDD (to reduce actually used PUCCH resources). As shown in Table 7 in the following, it may use ARO.

TABLE 7

| ACK/NACK Resource | |
|---|---|
| offset field in DCI | |
| format 1A/1B/1D/ | |
| 1/2A/2/2B/2C/2D | Δ_{ARO} |
| 0 | 0 |
| 1 | $- {\sum }_{i 1 = 0}^{m - 1} {N}_{ECCE , q , n - {k}_{i 1}} - 2$ |
| 2 | $- {\sum }_{i 1 = m - ⌈ m \text{/} 3 ⌉} {N}_{ECCE , q , n - {k}_{i 1}} - 1$ |
| 3 | 2 |

In Table 7, when HARQ-ACK is transmitted in a UL subframe in response to a plurality of DL subframes, m corresponds to indexes of a plurality of the DL subframes and N_{eCCE,q,n-ki1} corresponds to the number of ECCEs of an EPDCCH PRB set q.

In Table 7, when an ACK/NACK resource offset field corresponds to 1, an ARO value corresponds to a value configured to move a position to a HARQ-ACK resource of a first subframe among a plurality of the DL subframes. When the ACK/NACK resource offset field corresponds to 2, an ARO value corresponds to a value configured to move a position to a HARQ-ACK resource of 1, 2, or 3 preceding subframe among a plurality of the DL subframes (The number of skipped subframes may vary according to a position of a subframe. For the specific number of skipped subframes, it may refer to the equation shown in Table 7.) A PUCCH resource can be efficiently compressed via the ARO value. In the following, for clarity, an ARO value configured to move a position to a HARQ-ACK resource of a first subframe is referred to as a first large value ARO value and an ARO configured to move a position to one of preceding subframes is referred to as a second large value ARO value.

A PUCCH resource can be determined by equation 3 when the EPDCCH PRB set q is used for the distributed transmission and a PUCCH resource can be determined by equation 4 when the EPDCCH PRB set q is used for the localized transmission.

$$\begin{matrix}{n}_{PUCCH}^{( 1 , {\tilde{p}}_{1} )} = {n}_{ECCE , q} + 1 + {\sum }_{i 1 = 0}^{m - 1} {N}_{ECCE , q , n - {k}_{i 1}} + {Δ}_{ARO} + {N}_{PUCCH , q}^{( el )} & [ Equation 3 ] \\ {n}_{PUCCH}^{( 1 , {\tilde{p}}_{1} )} = ⌊ \frac{{n}_{ECCE , q}}{{N}_{RB}^{ECCE , q}} ⌋ \cdot {N}_{RB}^{ECCE , q} + 1 + {\sum }_{i 1 = 0}^{m - 1} {N}_{ECCE , q , n - {k}_{i 1}} + {n}^{′} + {Δ}_{ARO} + {N}_{PUCCH , q}^{( el )} & [ Equation 4 ]\end{matrix}$$

In equations 3 and 4, n_{ECCE,q} corresponds to a lowest ECCE index, N_{PUCCH,q}^{(el)} corresponds to a parameter given by higher layer signaling, n′ corresponds to a value determined in relation to an antenna port, and N_{eCCE,q,n-ki1} corresponds to the number of ECCEs of the EPDCCH PRB set q in a subframe n-kᵢ₁.

An LC-MTC UE is referred to as an MTC UE in the following. Similar to a legacy UE, the MTC UE can determine a HARQ ACK resource. In this case, the MTC UE can also be referred to as a BL/CE (Bandwidth-reduced Low-complexity or Coverage Enhanced) UE.

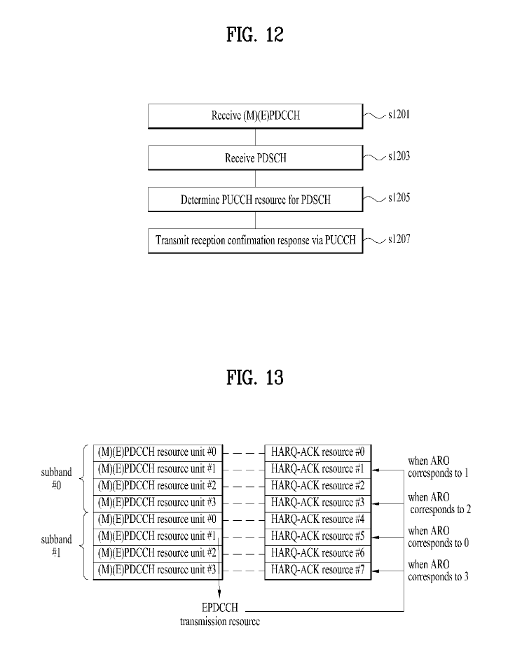

FIG. 12 is a flowchart of a method for an MTC UE to determine a PUCCH resource for transmitting HARQ ACK. Referring to FIG. 12, in the step S1201, an LC-MTC UE receives a control channel on a specific subband only. In the following, the control channel is referred to as an MPDCCH (MTC physical downlink control channel). The MPDCCH and EPDCCH may have the similar characteristic. In the step S1203, the MTC UE receives PDSCH based on the MPDCCH. In the step S1205, the MTC UE determines a PUCCH resource to transmit a reception confirmation response that indicates whether or not the PDSCH is successfully received. In the step S1207, the MTC UE transmits the reception confirmation response to an eNB on PUCCH. In the following, a method of determining the PUCCH resource is explained in detail in relation to the step S1205.

Similar to a legacy EPDCCH-related operation, a HARQ-ACK resource is mapped to each of resource units of the MPDCCH and it may be able to configure UEs scheduled by a different resource unit to automatically feedback with a different HARQ-ACK resource (i.e. PUCCH resource).

Assume that the MPDCCH exists in every subband. In this case, if the MPDCCH is received using a subband index #m, it is necessary to map a HARQ-ACK resource by avoiding a HARQ-ACK resource mapped to an EPDCCH resource unit of a subband including an index smaller than the subband index #m. For example, the abovementioned mapping method can be represented as equations 5 and 6.

$$\begin{matrix} {n}_{PUCCH}^{( 1 , {\tilde{p}}_{0} )} = {n}_{ECCE} + {\sum }_{i = 0}^{m - 1} {N}_{ECCE , i} + {Δ}_{ARO} + {N}_{PUCCH}^{( el )} & [ Equation 5 ] \\ {n}_{PUCCH}^{( 1 , {\tilde{p}}_{0} )} = ⌊ \frac{{n}_{ECCE}}{{N}_{RB}^{ECCE}} ⌋ \cdot {N}_{RB}^{ECCE} + 1 + {\sum }_{i = 0}^{m - 1} {N}_{ECCE , i} + {n}^{′} + {N}_{PUCCH}^{( el )} + {Δ}_{ARO} & [ Equation 6 ]\end{matrix}$$

In this case, a PUCCH resource can be determined by equation 5 when an MPDCCH PRB set is used for the distributed transmission and a PUCCH resource can be determined by equation 6 when the MPDCCH PRB set is used for the localized transmission. In this case, each of parameters is described in the following.

n_{ECCE}: This parameter corresponds to an index of a first resource unit configuring the MPDCCH. For example, this parameter corresponds to an index of a lowest ECCE configuring the MPDCCH.

N_{ECCE,i}: This parameter indicates the number of MPDCCH resource units existing in a subband index i. For example, this parameter indicates the number of ECCEs existing in the subband index i.

N_{PUCCH}^{(el)}: This parameter corresponds to an offset value for designating a first position of an HARQ-ACK resource used by an MTC UE. In particular, this parameter may correspond to a value designated via higher layer signaling.

N_{RB}^{ECCE}: This parameter corresponds to the number of resource units per PRB pair.

n′: This parameter corresponds to a parameter determined by a DM-RS antenna port of the MPDCCH.

Δ_{ARO}: This parameter corresponds to a HARQ-ACK resource offset value indicated by an eNB via the MPDCCH. This parameter can be indicated by a resource offset field of a DCI format.

In this case, a resource unit of the MPDCCH may correspond to a legacy ECCE as a unit of a time-frequency resource constructing the MPDCCH. Yet, if a minimum aggregation level (L) increases for coverage enhancement, a resource unit consisting of a plurality of ECCEs may become the resource unit of the MPDCCH.

The equations 5 and 6 correspond to equations derived from an equation of determining HARQ-ACK resource of a legacy EPDCCH. In case of the legacy EPDCCH, two UEs, which are scheduled by EPDCCH transmitted from a different subframe, use a different HARQ-ACK resource. On the other hand, according to the equations 5 and 6, two UEs, which are scheduled by the same resource unit index in a different subband, use a different HARQ-ACK resource. This is because an offset corresponding to the sum of the number of resource units corresponding to a subband of an index smaller than the m is assigned via a variable corresponding to

$${\sum }_{i = 0}^{m - 1} {N}_{ECCE , i} .$$

When the abovementioned operation is performed, if MPDCCH is not transmitted in a subband of a lower index, a HARQ-ACK resource for transmitting the MPDCCH can be wasted in the subband. Hence, the present invention proposes a method of appropriately designating _{ARO} to efficiently utilize HARQ-ACK resources. In the following, the Δ_{ARO} is referred to as an ARO value or ARO. According to the present invention, if a UE, which is scheduled via MPDCCH of a different subband, uses an empty HARQ-ACK resource by appropriately designating the ARO, it may be able to more efficiently utilize resources.

To this end, the present invention propose a DCI offset field to have an ARO value, which is determined according to a subband index, in MPDCCH that schedules PDSCH of an MTC UE.

Specifically, it may be able to configure at least a part of ARP values, which are indicated by a DCI offset field of MPDCCH transmitted via a subband m, to have a value of such a form as

$$- {\sum }_{i = 0}^{m - 1} {N}_{ECCE , i} + a .$$

As a result, it may be able to configure one of HARQ-ACK resources of MPDCCH of a subband index 0 to be used. In particular, the abovementioned operation may correspond to a form of moving the PUCCH resource to a PUCCH resource corresponding to a second subband of an index lower than the index of the first subband. If the ARO value is inserted into the equation of the aforementioned distributed MPDCCH case, it may have such a form as equation 7 described in the following.

$${n}_{PUCCH}^{( 1 , {\tilde{p}}_{0} )} = {n}_{ECCE} + a + {N}_{PUCCH}^{( el )} \qquad [ Equation 7 ]$$

According to the equation 7, it may be able to use a HARQ-ACK resource of MPDCCH where an index of a resource unit becomes n_{ECCE}+a among MPDCCHs of a subband index 0.

In case of using 2-bit ARO, an ARO value of each state can be given as Table 8 in the following. In this case, a or b corresponds to a predetermined value and the value corresponds to an offset to be additionally applied to n_{ECCE} after moving to a region of the subband index 0.

TABLE 8

| ACK/NACK Resource | |
|---|---|
| offset field in DCI | |
| format 1A/1B/1D/ | |
| 1/2A/2/2B/2C/2D | Δ_{ARO} |
| 0 | 0 |
| 1 | $- {\sum }_{i = 0}^{m - 1} {N}_{ECCE , i} + a$ |
| 2 | $- {\sum }_{i = 0}^{m - 1} {N}_{ECCE , i} + b$ |
| 3 | 2 |

Preferably, for a or b, it may be preferable to select a value from among −2, −1, 0, 1, and 2. This is because, if the a or the b is configured by an excessively big absolute value, it may make the value deviate from a region of a subband index 0 again.

In Table 8, if an ARO field, i.e. a resource offset field in a DCI format, is designated by 0 or 3, a HARQ-ACK resource belonging to a region of a subband m is used again. It is preferable to use the value when a HARQ-ACK resource, which is capable of being designated by 1 or 2 of the ARO field, located at the region of the subband index 0 is unavailable.

Meanwhile, in Table 8, although it is described as a DCI format corresponds to 1A/1B/1D/1/2A/2/2B/2C/2D, it may use a DCI format newly defined for an MTC UE as well. If a DCI format 3 is defined for an MTC UE, an offset field value received through the DCI format 3 can be used as an ARO field. In this case, each state of the offset field can indicate an ARO value according to Table 8.

FIG. 13 is a diagram for explaining a method of determining a HARQ-ACK resource according to an ARO value in accordance with one embodiment of the present invention. In FIG. 13, assume a case that Table 8 is used for two subbands. In particular, assume that a and b correspond to 0 and 2, respectively.

Referring to FIG. 13, a UE is scheduled by an EPDCCH resource #1 of a subband #1. In this case, if an ARO field value corresponds to 0, a HARQ-ACK resource #5 originally mapped to the EPDCCH resource #1 is used. Otherwise, it may be able to determine HARQ-ACK resource according to an offset designated by an ARO field. In particular, if the ARO field value corresponds to 1 or 2, it is able to see that a HARQ-ACK resource mapped to a subband #0 is used. In this case, it is assumed that an offset value for a HARQ resource region of an MTC UE corresponds to 0.

Meanwhile, when the number of subbands is very big, if all of the subbands move to a HARQ-ACK region of the subband index 0 and select a resource, there are so many duplicated selections and it may be difficult to use a corresponding ARO value. In this case, it is preferable to move a partial ARO value to a HARQ-ACK region of a different subband rather than the subband index 0.

For example, when a resource is scheduled via MPDCCH of a subband m, it may move to a HARQ-ACK region of a subband Y (>=0) by having such an ARO value as

$$- {\sum }_{i = Y}^{m - 1} {N}_{ECCE , i} + b .$$

Specifically, a value of Y may correspond to a value determined by a value of m rather than a fixed value. In particular, if a resource is scheduled by a subband of a bigger index by increasing the value of Y in accordance with the increase of the value of m, it may be able to move to a HARQ-ACK region of a subband of a relatively big index.

For example, when a 2-bit ARO is used, an ARO value corresponding to each state can be given as Table 9 in the following. If an ARO field is configured by 2, it may move to a HARQ-ACK region of a subband m-ceil(m/X). This corresponds to a case that Y=m-ceil(m/X) is satisfied.

TABLE 9

| ACK/NACK Resource | |
|---|---|
| offset field in DCI | |
| format 1A/1B/1D/ | |
| 1/2A/2/2B/2C/2D | Δ_{ARO} |
| 0 | 0 |
| 1 | $- {\sum }_{i = 0}^{m - 1} {N}_{ECCE , i} + a$ |
| 2 | $- {\sum }_{i = m - ⌈ m \text{/} X ⌉}^{m - 1} {N}_{ECCE , i} + b$ |
| 3 | 2 |

In the foregoing description, a case of mapping HARQ-ACK resource to every resource unit of MPDCCH has been described. In case of an MTC operation, a HARQ-ACK resource can be mapped to every resource of PDSCH. For example, one HARQ-ACK resource can be mapped to every RB belonging to an MTC subband or every subband of MTC. In this case, an MPDCCH resource unit can be replaced with a PDSCH resource unit. And, an operation via the aforementioned ARO field can be applied as well. For example, if the ARO field corresponds to 1, it may be able to use a HARQ-ACK resource interlocked with a PDSCH resource unit transmitted in a subband 0.

Meanwhile, a field corresponding to 2 is included in legacy ARO values. This is because, when a UE equipped with a plurality of Tx antennas transmits HARQ-ACK, since the UE performs an operation of selecting two continuous resources and transmitting HARQ-ACK using each antenna in each of two resources, the field corresponding to 2 is used for the purpose of avoiding the two continuous resources. Yet, since an MTC UE basically operates using a single Tx antenna, it may be preferable to use an ARO value corresponding to 2 by modifying the value to 1. For example, in the above Table, an ARO value corresponding to an offset 3 may correspond to 1.

Similar to Table 8, in Table 9, although it is described as a DCI format corresponds to 1A/1B/1D/1/2A/2/2B/2C/2D, it may use a DCI format newly defined for an MTC UE as well. If a DCI format 3 is defined for an MTC UE, an offset field value received through the DCI format 3 can be used as an ARO field. In this case, each state of the offset field can indicate an ARO value according to Table 9.

In the following, a method of identifying the number of resource units belonging to a different subband is explained based on the aforementioned operation.

Since an MTC UE is able to perform reception in a subband related to the MTC UE only, the MTC UE does not know the exact number of resource units defined in a different subband. Hence, an eNB can inform the MTC UE of the number of resource units set to each subband in advance via a higher layer signal such as RRC. In this case, the UE can calculate an ARO value according to the aforementioned operation based on the number of resource units indicated by the eNB.

As a different embodiment of calculating the ARO value, the UE can calculate the number of resource units under the assumption that a configuration of a subband currently monitored by the UE is identically set to a different subband while the eNB does not inform the UE of the number of resource units. According to the present method, a somewhat incorrect operation may occur. Yet, signaling for indicating the number of resource units per subband can be omitted.

However, when MPDCCH is not configured in a specific subband, if the abovementioned assumption is applied, it may cause an excessive error of an ARO value. Hence, the eNB may signal the UE on whether or not a resource unit exists in a certain subband. In this case, the UE may assume that a subband at which a resource unit exists has a configuration identical to a configuration of a subband monitored by the UE.

When the abovementioned operation is performed, it is necessary to define a meaning of a subband index in more detail in environment in which subband hopping is performed. When a specific UE receives MPDCCH or PDSCH in a specific subband only, if the subband is in a poor channel state, overall performance can be deteriorated. Hence, the subband hopping corresponds to an operation of a UE that changes the subband on which PDCCH or PDSCH is received according to a predetermined pattern over time. In this case, in the ARO configuration operation, since a subband index is related to a physical position of a subband, if the UE performs the subband hopping, an index of a subband on which MPDCCH or PDSCH is received can be changed.

As a further different embodiment of calculating the ARO value, if the eNB configures an ARO value according to a subband, i.e. a value corresponding to an ARO field value, via a higher layer signal such as RRC and the UE receives MPDCCH or PDSCH in a specific subband, it may be able to configure the UE to use an ARO value set to the subband. The present scheme is efficient in that the eNB is able to directly control an ARO value to be used in each subband. In this case, in order to reduce signaling overhead, a value corresponding to a specific ARO field value is controlled only by signaling and the remaining values can be fixed by a specific value in advance.

As a further different embodiment of calculating the ARO value, a subband index may correspond to a logical index and may be irrelevant to subband hopping. A point at which a subband of the logical index is physically positioned can be configured to be changed according to a hopping pattern. In this case, a subband index does not change in the ARO configuration operation.

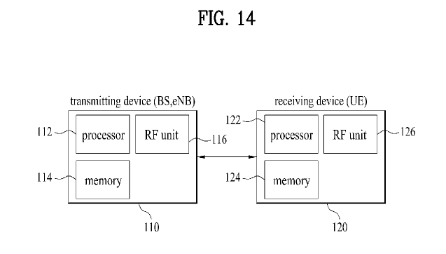

FIG. 14 illustrates a base station and a user equipment applicable to one embodiment of the present invention. If a relay is included in a system, the base station or the user equipment can be replaced with the relay.

Referring to FIG. 14, a wireless communication system includes a base station 110 and a user equipment 120. The base station 110 includes a processor 112, a memory 114 and a radio frequency (RF) unit 116. The processor 112 can be configured to implement a procedure and/or methods proposed by the present invention. The memory 114 is connected with the processor 112 and stores various information associated with operations of the processor 112. The RF unit 116 is connected with the processor 112 and transmits and/or receives a radio signal. The user equipment 120 includes a processor 122, a memory 124 and a radio frequency (RF) unit 126. The processor 122 can be configured to implement a procedure and/or methods proposed by the present invention. The memory 124 is connected with the processor 122 and stores various information associated with operations of the processor 122. The RF unit 126 is connected with the processor 122 and transmits and/or receives a radio signal. The base station 110 and/or the user equipment 120 can include a single antenna or multiple antennas.

The above-mentioned embodiments correspond to combinations of elements and features of the present invention in prescribed forms. And, it is able to consider that the respective elements or features are selective unless they are explicitly mentioned. Each of the elements or features can be implemented in a form failing to be combined with other elements or features. Moreover, it is able to implement an embodiment of the present invention by combining elements and/or features together in part. A sequence of operations explained for each embodiment of the present invention can be modified. Some configurations or features of one embodiment can be included in another embodiment or can be substituted for corresponding configurations or features of another embodiment. And, it is apparently understandable that an embodiment is configured by combining claims failing to have relation of explicit citation in the appended claims together or can be included as new claims by amendment after filing an application.

In this disclosure, embodiments of the present invention are mainly explained centering on data transmission/reception relation between a user equipment and a base station. A specific operation explained as performed by a base station may be performed by an upper node of the base station in some cases. In particular, in a network constructed with a plurality of network nodes including a base station, it is apparent that various operations performed for communication with a user equipment can be performed by a base station or other networks except the base station. ‘base station’ may be substituted with such a terminology as a fixed station, a Node B, an eNode B (eNB), an access point (AP) and the like. And, ‘terminal’ may be substituted with such a terminology as a user equipment (UE), a mobile station (MS), a mobile subscriber station (MSS), and the like.

Embodiments of the present invention can be implemented using various means. For instance, embodiments of the present invention can be implemented using hardware, firmware, software and/or any combinations thereof. In the implementation by hardware, a method according to each embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known in public.

The present invention may be carried out in other specific ways than those set forth herein without departing from the spirit and essential characteristics of the present invention. The above detailed description is therefore to be construed in all aspects as illustrative and not restrictive. The scope of the invention should be determined by reasonable interpretation of the appended, and all changes coming within the meaning and equivalency range of the appended claims are to be embraced therein. Claims that are not explicitly cited in the appended claims may be presented in combination as an exemplary embodiment of the present invention or included as a new claim by subsequent amendment after the application is filed.

### INDUSTRIAL APPLICABILITY

The present invention is applicable to a UE, an eNB, and other devices (e.g., relay). Specifically, the present invention can be applied to a method of transmitting control information and an apparatus therefor.

What is claimed is:

1. A method of transmitting uplink control information, which is transmitted by an MTC (machine type communication) UE in a wireless communication supporting MTC, the method comprising:
receiving, by the MTC UE, an MPDCCH (MTC physical downlink control channel) in a first subband from a base station;
receiving a PDSCH (physical downlink shared channel) based on the MPDCCH;
determining a PUCCH (physical uplink control channel) resource for the PDSCH using an ARO (HARQ-ACK resource offset) indicated by the MPDCCH; and
transmitting the uplink control information via the PUCCH resource,
wherein the ARO is defined to move the PUCCH resource to a PUCCH resource corresponding to a second subband of an index lower than an index of the first subband.

2. The method of claim 1, wherein an amount of movement of the PUCCH resource moved by the ARO is determined based on the index of the first subband.

3. The method of claim 1, wherein the ARO corresponds to
$$- {\sum }_{i = Y}^{m - 1} {N}_{ECCE , i} + a ,$$
wherein the m corresponds to the index of the first subband, wherein the i corresponds to an index of a subband on which a specific MPDCCH is transmitted, wherein the N_{ECCE,I} corresponds to the number of resource units existing in the subband index i, and wherein the a corresponds to an offset value.

4. The method of claim 3, wherein the Y corresponds to 0.

5. The method of claim 3, wherein the Y is determined according to the index of the first subband.

6. The method of claim 3, wherein the ARO is calculated under the assumption that the number of MPDCCH resource units is consistent in the subband.

7. A method of receiving uplink control information, which is received by a base station in a wireless communication supporting MTC (machine type communication), the method comprising:
transmitting, by the base station, an MPDCCH (MTC physical downlink control channel) to an MTC UE in a first subband;
transmitting a PDSCH (physical downlink shared channel) based on the MPDCCH; and
receiving the uplink control information on the PDSCH from the MTC UE via a PUCCH (physical uplink control channel) resource,
wherein the PUCCH resource is determined using an ARO (HARQ-ACK resource offset) and wherein the ARO is defined to move the PUCCH resource to a PUCCH resource corresponding to a second subband of an index lower than an index of the first subband.

8. The method of claim 7, wherein an amount of movement of the PUCCH resource moved by the ARO is determined based on the index of the first subband.

9. The method of claim 7, wherein the ARO corresponds to
$$- {\sum }_{i = Y}^{m - 1} {N}_{ECCE , i} + a ,$$
herein the m corresponds to the index of the first subband, wherein the i corresponds to an index of a subband on which a specific MPDCCH is transmitted, wherein the N_{ECCE,I} corresponds to the number of resource units existing in the subband index i, and wherein the a corresponds to an offset value.

10. The method of claim 9, wherein the Y corresponds to 0.

11. The method of claim 9, wherein the Y is determined according to the index of the first subband.

12. The method of claim 9, wherein the ARO is calculated under the assumption that the number of MPDCCH resource units is consistent in the subband.

13. An MTC (machine type communication) UE transmitting uplink control information in a wireless communication supporting MTC, the MTC UE comprising:
a transceiver configured to transceive a signal with a base station; and
a processor
wherein the processor is configured to receive an MPDCCH (MTC physical downlink control channel) in a first subband from a base station, to receive a PDSCH (physical downlink shared channel) based on the MPDCCH, determine a PUCCH (physical uplink control channel) resource for the PDSCH using an ARO (HARQ-ACK resource offset) indicated by the MPDCCH, and transmit the uplink control information via the PUCCH resource,
wherein the ARO is defined to move the PUCCH resource to a PUCCH resource corresponding to a second subband of an index lower than an index of the first subband.

14. A base station receiving uplink control information in a wireless communication supporting MTC (machine type communication), the base station comprising:
a transceiver configured to transceive a signal with a MTC user equipment (UE); and
a processor
wherein the processor is configured to transmit an MPDCCH (MTC physical downlink control channel) to an MTC UE in a first subband, to transmit a PDSCH (physical downlink shared channel) based on the MPDCCH, and receive the uplink control information on the PDSCH from the MTC UE via a PUCCH (physical uplink control channel) resource,
wherein the PUCCH resource is determined using an ARO (HARQ-ACK resource offset) and wherein the ARO is defined to move the PUCCH resource to a PUCCH resource corresponding to a second subband of an index lower than an index of the first subband.
